(19) United States
(12) Patent Application Publication
(10) Pub. No.: US 2012/0144442 A1
(43) Pub. Date: Jun. 7, 2012

(54) RESIDENTIAL GATEWAY AND METHOD FOR REDUCING CHANNEL ZAPPING TIME

(75) Inventors: MING-CHOU CHIANG, Tu-Cheng (TW); CHUN HSU, Tu-Cheng (TW)

(73) Assignee: HON HAI PRECISION INDUSTRY CO., LTD., Tu-Cheng (TW)

(21) Appl. No.: 12/972,554

(22) Filed: Dec. 20, 2010

(30) Foreign Application Priority Data
Dec. 6, 2010 (CN) 201010574552.5

(51) Int. Cl. H04N 7/173

(52) U.S. Cl. 725/109; 725/131

(57) ABSTRACT

A method for reducing channel zapping time is executed by a residential gateway. The method comprises predicting the next channel the client device will request and storing the most recent I-frames of each channel adjacent to the current channel in the same frequency band into a buffer. While a current channel is tuned by one tuner, using the other tuner for locking onto the frequency of the predicted channel if the predicted channel and the current channel are not in the same frequency band. If the prediction is correct, the total channel zapping time is reduced by saving tuner locking time. If the predicted channel and the current channel are in the same frequency band and the prediction is correct, the total channel zapping time is reduced by presenting the stored I-frame immediately.

### BACKGROUND

1. Technical Field

The present disclosure relates to internet protocol television (IPTV), and more particularly, to a residential gateway and method for reducing channel zapping time for IPTV service.

2. Description of Related Art

IPTV is one of the most attractive multimedia related services to customers. A home network usually comprises a residential gateway which serves as a single entry point for transmitting IPTV channel content to all client devices in the home network. However, the residential gateway cannot transmit all the IPTV channels at the same time due to bandwidth limitation. Therefore, only a part of channels are immediately available at the residential gateway, and some delay is inevitable during switching to a new channel when it is not available at the residential gateway. The channel switching delay is also known as channel zapping time. Reducing channel zapping time is one of the key features to the successful of IPTV service in the residential gateway.

### BRIEF DESCRIPTION OF THE DRAWINGS

FIG. 1 is a schematic diagram of one embodiment of a network environment in which the present disclosure may be practiced.

FIG. 2 is a block diagram of one embodiment of a residential gateway.

FIG. 3 is a state transition diagram of one embodiment of a tuner.

FIG. 4 is a flowchart of one embodiment of operations that may be performed by a tuner management module.

FIG. 5A is a flowchart of one embodiment of operations that may be performed by a processor.

FIG. 5B is a flowchart of one embodiment of operations that may be performed by a processor.

FIG. 5C is a flowchart of one embodiment of operations that may be performed by a processor.

FIG. 5D is a flowchart of one embodiment of operations that may be performed by a processor.

FIG. 5E is a flowchart of one embodiment of operations that may be performed by a processor.

FIG. 6 is a flowchart of one embodiment of operations that may be performed by a channel buffering module.

FIG. 7 is a flowchart of one embodiment of operations that may be performed by a channel selection module.

### DETAILED DESCRIPTION

In the following description, the term “current channel” as used herein refers to the channel currently played on a client device. The term “adjacent channels” as used herein refers to channels neighboring the main channel in a same frequency band. The term “desired channel” as used herein refers to the channel to be selected according to a channel change request of the client device. The term “desired frequency” as used herein refers to the frequency band of the desired channel. The term “predicted channel” as used herein refers to the channel expected to be selected in a next channel change request of the client device. The term “predicted frequency” as used herein refers to the frequency band of the predicted channel.

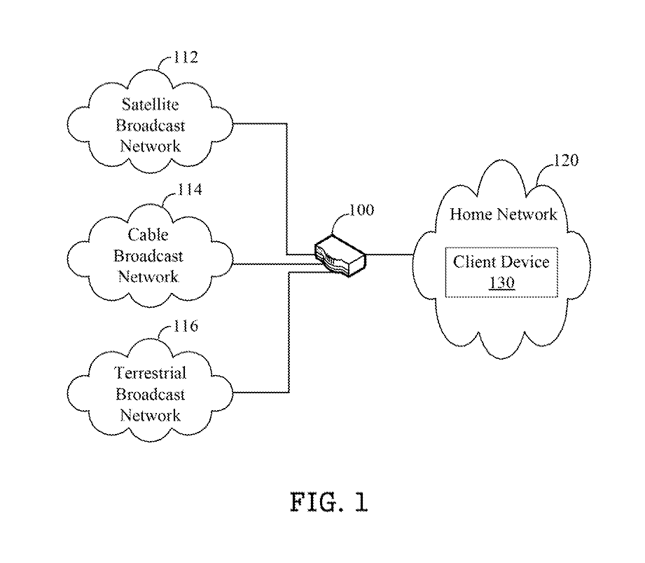

With reference to FIG. 1, a schematic diagram of one embodiment of a network environment in which the present disclosure may be practiced is illustrated. The network environment comprises a residential gateway 100, a satellite broadcast network 112, a cable broadcast network 114, a terrestrial broadcast network 116, a home network 120 and one or more client devices 130. The residential gateway 100 is capable of receiving transport streams from the satellite broadcast network 112, the cable broadcast network 114 and/or the terrestrial broadcast network 116, and redistributing the received transport streams to the client device 130 in the home network 120. The home network 120 may comprise at least one client device 130 that is connected to the residential gateway 100. The client device 130 may comprise any computing device capable of receiving and sending IP packets over the home network 120. The client device 130 can be IP set top box, a desktop computer, a notebook computer, or a mobile phone, for example.

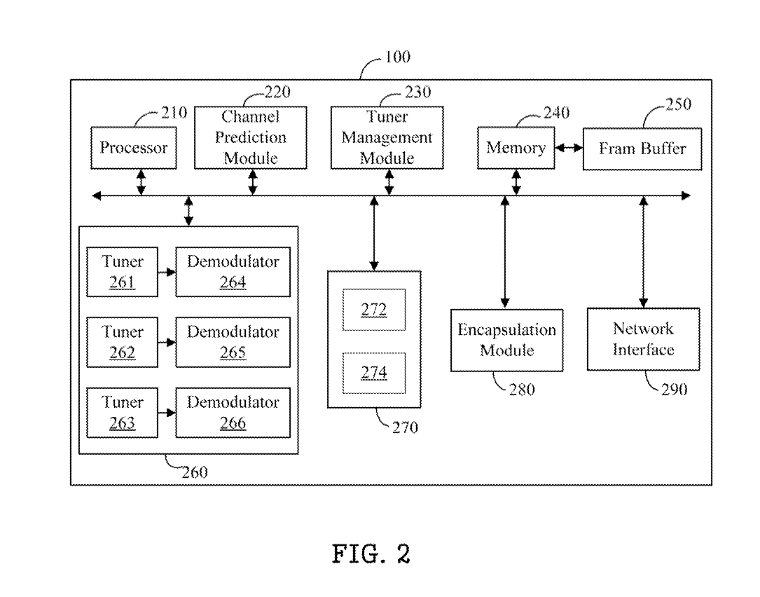

Please reference to FIG. 2, illustrates a block diagram of one embodiment of the residential gateway 100. In one embodiment, the residential gateway 100 may have one or more processors 210, a channel prediction module 220, a tuner management module 230, a memory 240, a frame buffer 250, a tuning unit 260, a channel management module 270, a encapsulation module 280, and one or more network interfaces 290. The residential gateway interfaces to the home network 120 via the network interface 290, which may be either a non-wireless medium or a wireless medium. The word “module”, as used herein, refers to a collection of software instructions and may be stored in any type of computer-readable medium, such as the memory 240. One or more software instructions of the modules 220, 230 and 270 may be executed by the processor 210. The processor 210 controls the overall functions of the residential gateway 100 and is in communication with the channel prediction module 220, the tuner management module 230, the memory 240, the tuning unit 250, the channel manage module 270, the encapsulation module 280 and the network interface 290. In one embodiment, the processor 210 operates under control of logic embodied in firmware stored in the memory 240. A broadcast stream is broadcast by a head-end in the satellite broadcast network 112, the cable broadcast network 114 or the terrestrial broadcast network 116, received by the tuning unit 260 and encapsulated into IP packets by the encapsulation module 280 for distributing to the client device 130 via the network interface 290. The tuning unit 260 may comprise two or more tuners, such as the tuners 261-263, and two or more demodulators, such as the demodulators 264-266. Each tuner may lock onto a single frequency of one or more channels and each demodulator may demodulate one or multiple channels carried on the single frequency. For example, the tuners 261-263 may concurrently lock onto three different frequency bands and the demodulators 264-266 may demodulate one or more channels received from those three different frequency bands. The tuners 261-263 are controlled by the processor 210 and the tuner management module 230 to lock onto a specific frequency band. Further details of these modules 220, 230 and 270 and the frame buffer 250 will be explained below.

The channel prediction module 220 is operable to predict a likely next channel, also called predicted channel herein, to be selected in a next channel change request of the client device 130. In one embodiment, the channel prediction module 220 may be programmed to track channel change requests, identify channels that appear popular, and predict the popular channels will likely be requested next. For example, with time elapsing, the channel prediction module 220 can monitor watched channels in order to later predict channels likely to be requested by the client device 130. In one embodiment, the channel prediction module 220 may be programmed to apply a stochastic model, such as a semi-Markov process model to analyze the channel change requests of the client device 130. In such process model, the channel prediction module 220 could store records of previous channel change requests of the client device 130. Preferably, this information would be stored in the memory 240. When one channel is selected, the channel prediction module 220 would access the records for channel change request made when that channel was previously selected and determine a predicted channel based on that subset of previous channel change experience.

Locking onto the frequency band of any particular channel by a tuner, such as the tuners 261, 262 or 263, typically introduces a processing delay of between 30 ms to 200 ms, in one exemplary example. With above prediction, while a current channel is displayed with one tuner, the other tuners is locked onto the frequency band of a predicted channel in order to save above locking time. For example, the tuner 261 is used to tuned the current channel, while the tuner 263 is used to lock onto a predicted frequency. By locking onto a predicted frequency before a next channel change request is received, the total channel zapping time experienced by the user of the client device 130 may be reduced in the event that the predicted channel ultimately is the channel selected in the next channel change request. The channel prediction module 220 may make prediction for the client device 130 after a channel change request is received and processed by the processor 210. Whenever a predicted channel for the client device 130 is retrieved, the channel prediction module 220 would transmit the predicted channel to the processor 210. If the predicted channel and a current channel of the client device 130 are not in the same frequency band, the channel prediction module 220 would transmit a predicted frequency for the predicted channel to the tuner management module 230 for further processing.

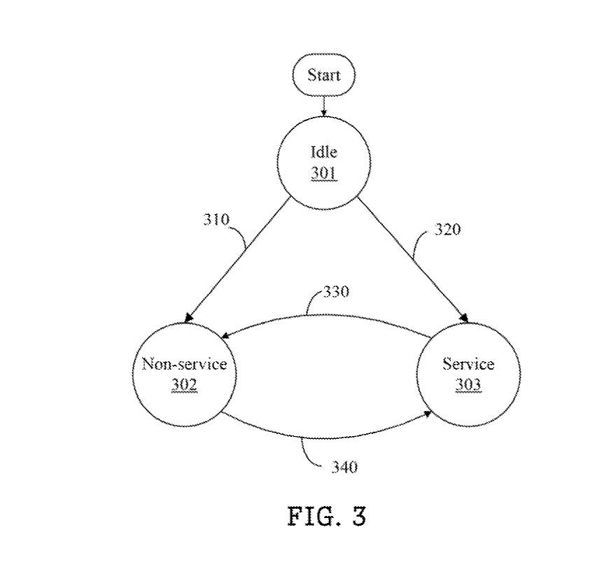

The tuner management module 230 is operable to select one tuner for locking onto the predicted frequency according to states of the tuners 261-263. The states of the tuners 261-263 may comprise idle state 301, non-service state 302 and service state 303. The idle state 301, as described herein, refers to initial states of the tuners 261-263. When the tuners 261, 262 or 263 is not locked onto any frequency band, the tuners 261, 262 or 263 may be in the idle state 301. When the tuners 261, 262 or 263 is locked onto a specific frequency band without serving any client device, the tuners 261, 262 or 263 is in the non-service state 302. When the tuners 261, 262 or 263 is providing broadcast service for the client device 130, the tuners 261, 262 or 263 is in the service state 303. FIG. 3 illustrates a state transition diagram of one embodiment of the tuners 261-263. The initial service states of the tuners 261-263 are in the idle state 301. While the tuners 261-263 are in the idle state 301, if one of the tuners 261-263 is selected by the tuner management module 230 for locking onto a predicted frequency, then the selected one of the tuners 261-263 would exit the idle state 301 and enter the non-service state 302 in accordance with a transition arc 310. While the tuner 261, the tuner 262 or the tuner 263 is in the idle state 301, if one of the tuners 261-263 is configured by the processor 210 to service a channel request of the client device 130, the selected one of the tuners 261-263 would exist the idle state 301 and enter the service state 303 in accordance with a transition arc 320. While the tuner 261, the tuner 262 or the tuner 263 is in the service state 303, if one of the tuner 261, the tuner 262 or the tuner 263 is configured by the processor 210 to stop providing broadcast to the client device 130, the selected one of the tuner 261, the tuner 262 or the tuner 263 would exist the service state 303 and enter the non-service state 302 in accordance with a transition arc 330. The tuners 261-263 may always remain locked onto the last-locked frequency band even the service states are changed from the service state 303 to the non-service state 302. While the tuner 261, the tuner 262 or the tuner 263 is in the non-service state 302, if one of the tuner 261, the tuner 262 or the tuner 263 is configured by the processor 210 to start providing broadcast to the client device 130, the selected one of the tuner 261, the tuner 262 or the tuner 263 would exist the non-service state 302 and enter the service state 303 in accordance with a transition arc 340.

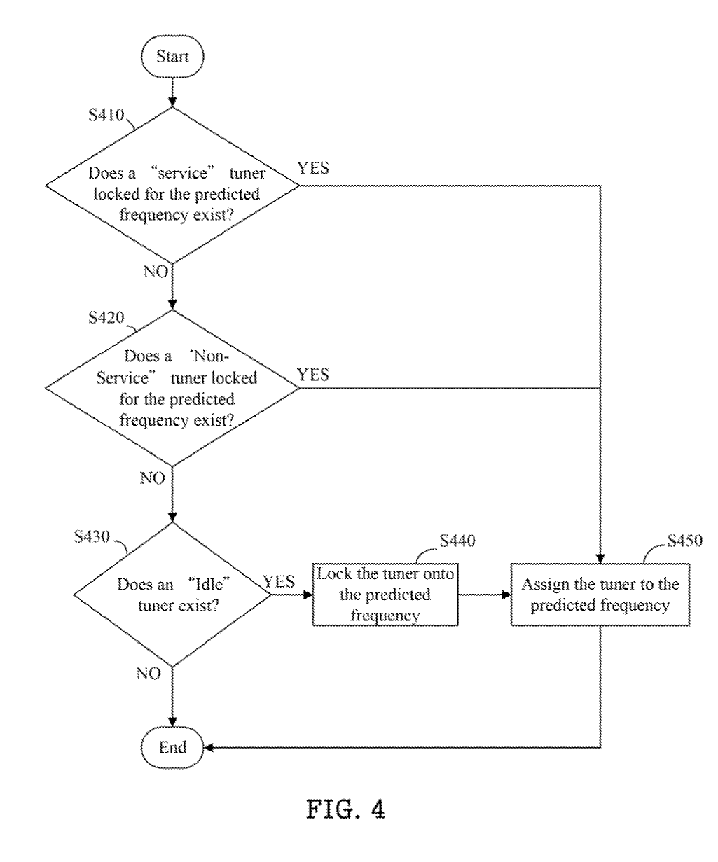

When the predicted frequency is received, the tuner management module may perform a tuner selection logic for selecting one tuner for locking onto the predicted frequency. FIG. 4 illustrates a flowchart of one embodiment of operations that may be performed by the tuner management module 230. In step S410, the tuner management module 230 tries to find one of the tuners in the service state 303 which is locked onto the predicted frequency. That is, if such tuner exists, the tuner management module 230 would assign the tuner for the predicted frequency in step S450. If such tuner does not exist in step S410, the tuner management module 230 tries to find one of the tuners in the non-service state 302 which is previously locked onto the predicted frequency in step S420. That is, if such tuner exists, the tuner management module 230 would assign the tuner for the predicted frequency in step S450. If such tuner does not exist in step S420, the tuner management module 230 tries to find one of the tuners in the idle state 301 in step S430. If such tuner exists, the tuner management module 230 would configure the tuner to lock onto the predicted frequency in step S440. At the same time, the tuner would exist the idle state 301 and enter the non-service state 302 in accordance with the transition arc 310, and the tuner would be assigned to the predicted frequency by the tuner management module 230 in step S450. If such tuner does not exist in step S430, the tuner management module 230 finishes the tuner selection logic without any tuner being selected.

In one example, the predicted frequency is 545 MHz, the tuner 261 is in the non-service state 302 and locked onto a frequency of 539 MHz, the tuner 262 is in the service state 303 and previously locked onto a frequency of 533 MHz and the tuner 263 is in the idle state 301. When the tuner management module 230 receives the predicted frequency, it would first check the tuner 262, which is in the service state 303, to determine if the tuner 262 is locked onto the predicted frequency of 545 MHz. In the example, because the tuner 262 is not satisfied the determination, the tuner management module 230 would next check the tuner 261, which is in the non-service state 302, to determine if the tuner 261 is previously locked onto the predicted frequency of 545 MHZ. In the example, because the tuner 261 is not satisfied the determination, the tuner management module 230 finally select the tuner 263, which is in the idle state 301. The tuner management module 240 would configure the tuner 263 to lock onto the predicted frequency of 545 MHZ and then assign the tuner 263 for the predicted frequency.

The processor 210 and the tuner management module 230 may maintain a tuner configuration table which may be stored in the memory 240 for managing the tuners 261-263. The tuner configuration table may be defined as shown in table 1.

TABLE 1

| Fields | Definitions |
|---|---|
| Tuner ID | Tuner Identifier |
| Frequency | Lock frequency |
| State | Idle State/Non-service State/Service State |
| Predicted | A Flag. True means the tuner is selected by the tuner |
| | management module, and False means otherwise. |
| Client Device List | User terminal list |

The content of the tuner configuration table could be updated by the processor 210 and the tuner management module 230. In one example, the tuner management module 230 would reference the tuner configuration table for retrieving current frequency and state of each one of the tuners 261-263 while operating the tuner selection logic. When the tuner management module 230 finishes tuner selection logic, it may update the predicted flag of one tuner being selected.

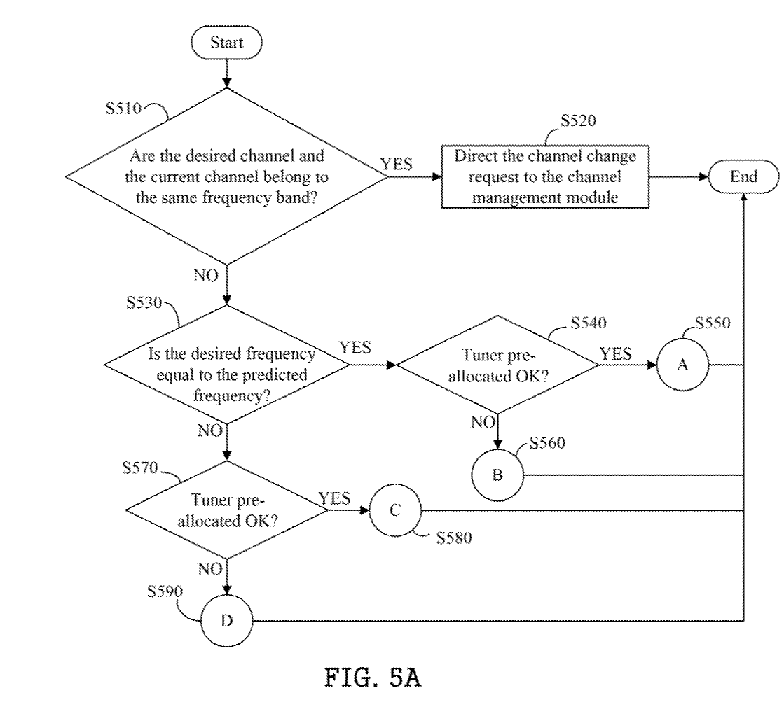

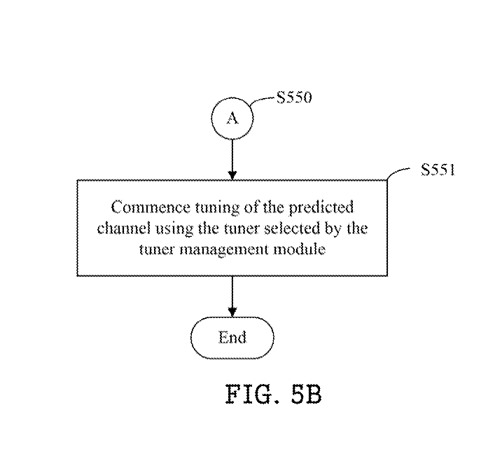

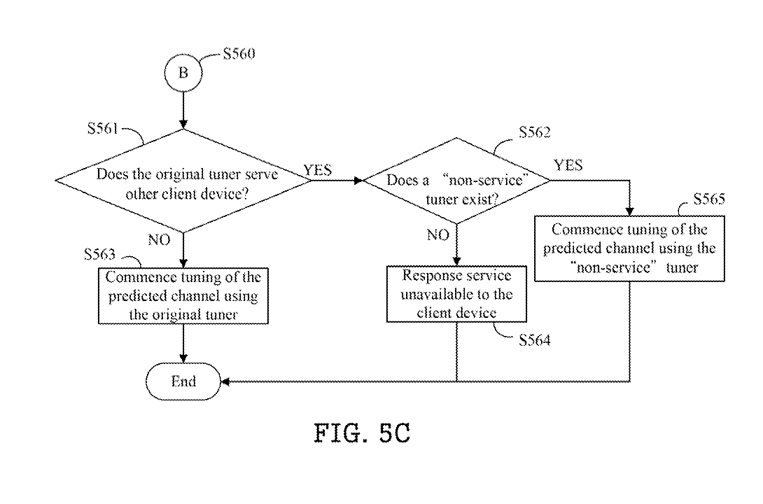

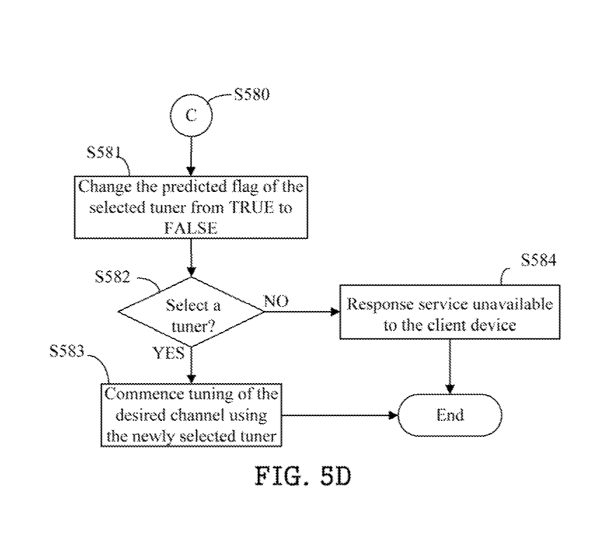

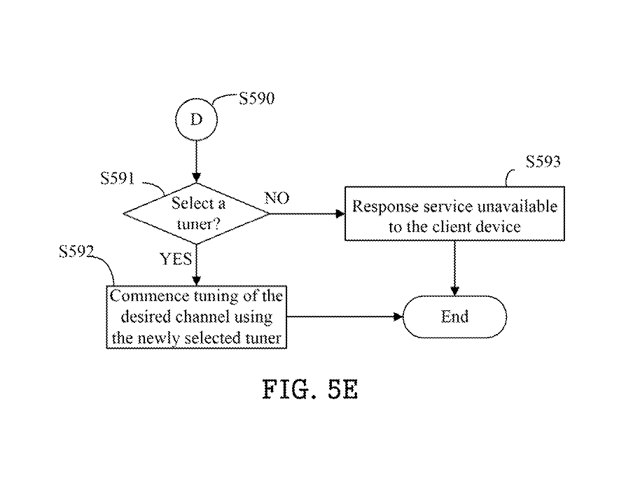

All channel change requests sent from the client device 130 would be received via the network interface 290 and processed by the processor 210. FIG. 5A illustrates a flowchart of one embodiment of operations that may be performed by the processor 210. When receives a channel change request, the processor 210 determines whether the desired channel and the current channel are belong to the same frequency band in step S510. If so, then the processor 210 directs the channel change request to the channel management module 270 for further processing in step S520. If the desired channel and the current channel both belongs to different frequency band in step S510, the processor 210 further determines whether the desired frequency equals to the predicted frequency in step S530. If so, the processor 210 further determines whether a tuner has been selected by the tuner management module 230 for locking onto the predicted frequency in step S540. If so, the processor 210 meets “A” condition, which means the prediction made by the channel prediction module 220 is correct and the tuner has been selected by the tuner management module 230, in step S550. If the processor 210 determines there is no tuner has been selected by the tuner management module 230 for locking onto the predicted frequency in step S540, then the processor 210 meets “B” condition in step S560. The “B” condition, as used herein, refers to the prediction made by the channel prediction module 220 is correct but there is no tuner has been selected by the tuner management module 230. If the processor determines the desired frequency is not equal to the predicted frequency in step S530, then the processor 210 further determines whether a tuner has been selected by the tuner management module 230 for locking onto the predicted frequency in step S570. If the processor 210 determines there is a tuner selected by the tuner management module 230 for locking onto the predicted frequency in step S570, the processor 210 meets “C” condition in step S580. The “C” condition, as used herein, refers to the prediction made by the channel prediction module 220 is not correct but there is a tuner selected by the tuner management module 230. If determining there is no tuner has been selected by the tuner management module 230 for locking onto the predicted frequency in step S570, the processor 210 meets “D” condition in the step S590. The “D” condition, as used herein, refers to the prediction made by the channel prediction module 220 is not correct and there is also no tuner has been selected by the tuner management module 230.

FIG. 5B illustrates a flowchart of one embodiment of operations that may be performed by the processor 210. When the processor 210 meets “A” condition in step S550, the processor 210 commences tuning of the predicted channel using the tuner selected by the tuner management module 230 in step S551, if the predicted flag of the tuner in the tuner configuration table is TRUE.

FIG. 5C illustrates a flowchart of one embodiment of operations that may be performed by the processor 210. When the processor 210 meets “B” condition in step S560, the processor 210 first determines whether the original tuner, which is tuned to the current channel, has been configured for serving other client devices by checking the client device list of the original tuner in the tuner configuration table in step S561. If determining the original tuner has been configured for serving multiple client device in step S561, the processor 210 further tries to select one tuner in the no-service state 302 in step S562. If there is a tuner in the non-service state 302, the processor 210 commences tuning of the predicted channel using the tuner in the non-service state 302 in step S565. If there are no tuners in the non-service state S302, the processor 210 responses the channel change request with service unavailable in step S564. If determining the original tuner only serving the client device 130 in the step S561, the processor 210 commences tuning of the predicted channel using the original channel.

FIG. 5D illustrates a flowchart of one embodiment of operations that may be performed by the processor 210. When the processor 210 meets “C” condition in step S580, the processor 210 change the predicted flag of the tuner selected by the tuner management module 230 from TRUE to FALSE in step S581. The processor 210 further tries to select one tuner based on principles of the tuner selection logic performed by the tuner management module 230 in step S582. If the processor 210 has selected a tuner in step S582, the processor 210 commences tuning of the desired channel using the tuner in step S583. If the processor 210 does not select any tuner in step S582, the processor 210 responses the channel change request of the client device 130 with service unavailable information in step S584.

Please reference to FIG. 5E, illustrates a flowchart of one embodiment of operations that may be performed by the processor 210. When the processor 210 meets “D” condition in step S590, the processor 210 tries to select one tuner based on principles of the tuner selection logic performed by the tuner management module 230 in step S591. If the processor 210 has selected a tuner in step S591, the processor 210 commences tuning of the desired channel using the tuner in step S592. If the processor 210 does not select any tuner in step S591, the processor 210 responses the channel change request of the client device 130 with service unavailable information in step S593.

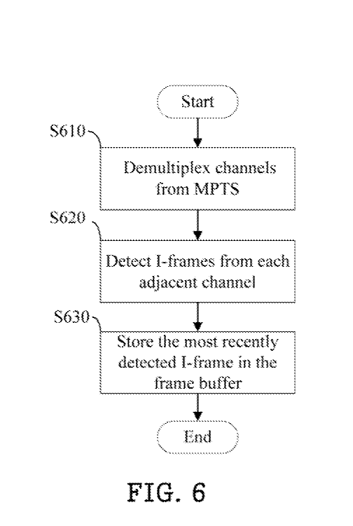

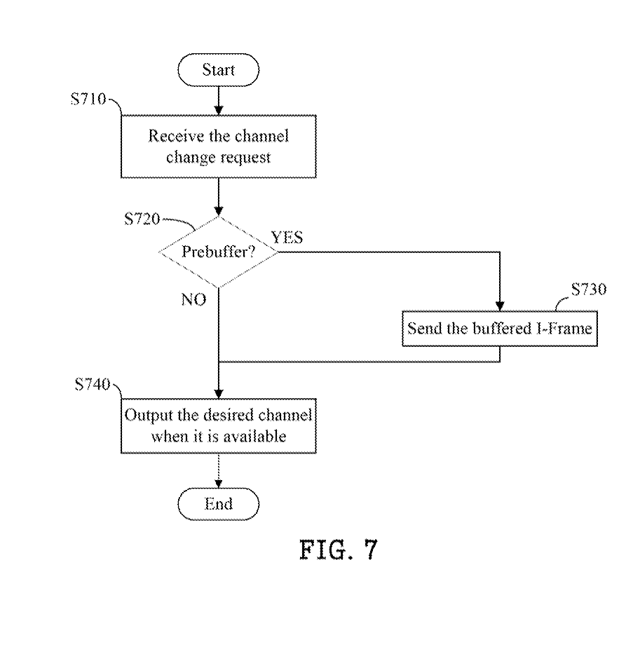

The channel management module 270 is operable to demultiplex channels from multiple program transport stream (MPTS) into separate single program transport stream (SPTS) and output a specific channel according to the channel change request of the client device 130. In one embodiment, the channel management module 270 may comprise a channel buffering module 272 and a channel selection module 274. Please reference to FIG. 6, illustrates a flowchart of one embodiment of operations that may be performed by a channel buffering module 272. The channels are demultiplexed from MPTS and separated in step S610. In step S620, I-frame are detected in each adjacent channel. In step S630, the channel buffering module 274 stores the most recent I-frame in the frame buffer 250 and continually refresh as each new I-frame is received. Please reference to FIG. 7, illustrates a flowchart of one embodiment of operations that may be performed by a channel selection module 274. The channel selection module 274 receives the channel change request sent from the processor 210 in step S710. In step S720, the channel selection module 274 determines whether the I-frame of the desired channel has been previously buffered. If so, the buffered I-frame is sent to the client device 130 immediately in step S730. If the desired channel was not buffered, the desired channel is presented whenever it becomes available in step S740.

The video sequence of the group of pictures layer is built upon the most recently received I-frame and its subsequent P-frame and B-frame. The I-frame is the critical first frame of the video sequence. In one example, a user of the client device 130 changes to a new channel at the point when, for example, the B-frame is currently received by the client device 130. Thus, the user cannot view this frame, as the basis I-frame has not been received by the client device 130. Instead, the user must wait until the next I-frame is received before being decoded and displayed on image from the newly changed channel. An average delay time for arrival of an I-frame, due to MPEG sequencing, may be approximately 250 milliseconds. With pebuffering the most recent I-frames for adjacent channels, the client device 130 does not need to wait for receiving the first I-frame while the desired channel is in the adjacent channels. It would reduce channel zapping time about 250 milliseconds average.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A residential gateway, connected to a client device, for reducing channel zapping time in the client device, the residential gateway comprising:
one or more processors;
a memory;
two or more tuners, wherein a first one of the tuners is configured to lock onto a first frequency of one or more channels and tune a first channel presented to the client device; and
one or more programs stored in the memory and configured to be executed by the one or more processors, the one or more programs comprising:
a channel prediction module for predicting a second channel to be likely selected in a next channel change request of the client device; and
a tuner management module for selecting a second one of the tuners to lock onto a second frequency of the second channel if the first channel and the second channel are in different frequency bands.

2. The residential gateway of claim 1, wherein the one or more programs further comprises:
a channel buffering module for receiving multiple program transport streams, separating channels from the multiple program transport streams, and storing a recent frame of at least one channel other than the first channel in the memory.

3. The residential gateway of claim 1, wherein the one or more programs further comprising:
a channel selection module for receiving a channel change request with a third channel, immediately presenting the third channel by sending a stored frame associated with the third channel.

4. The residential gateway of claim 3, wherein the stored frame is an I-frame.

5. The residential gateway of claim 1, wherein the second channel is predicted based on prior channel change requests of the client device.

6. A method for reducing channel zapping time of a residential gateway, comprising:
using a first tuner of the residential gateway to lock onto a first frequency and tune a first channel being presented to the residential gateway;
predicting a second channel to be likely selected in a next channel change request of the residential gateway; and
selecting a second one of the tuners to lock onto a second frequency of the second channel if the first channel and the second channel are in different frequency bands.

7. The method for reducing channel zapping time of claim 6, further comprising receiving multiple program transport streams, separating channels from the multiple program transport streams, and storing a recent frame of at least one channel other than the first channel.

8. The method for reducing channel zapping time of claim 6, further comprising receiving a channel change request with a third channel, immediately presenting the third channel by sending a stored frame associated with the third channel.

9. The method for reducing channel zapping time of claim 8, wherein the stored frame is an I-frame.

10. The method for reducing channel zapping time of claim 6, wherein the second channel is predicted based on prior channel change requests.
